(19) United States
(12) Patent Application Publication
(10) Pub. No.: US 2016/0187680 A1
(43) Pub. Date: Jun. 30, 2016

(54) An on-line actual-time monitoring method performed on manufacturing procedures for a display

(71) Applicant: Shenzhen China Star Optoelectronics Technology Co. Ltd., Shenzhen, Guangdong (CN)

(72) Inventor: Lixuan CHEN, Shenzhen, Guangdong (CN)

(73) Assignee: Shenzhen China Star Optoelectronics Technology Co. Ltd., Shenzhen, Guangdong (CN)

(21) Appl. No.: 14/428,360

(22) PCT Filed: Jan. 20, 2015
(86) PCT No.: PCT/CN2015/071137

§ 371 Date: Mar. 14, 2015

(30) Foreign Application Priority Data
Dec. 30, 2014 (CN) 201410841139.9

(51) Int. Cl. G02F 1/13; G02F 1/1333

(52) U.S. Cl. CPC G02F 1/1309; G02F 1/1333

(57) ABSTRACT

An on-line actual-time monitoring method performed on manufacturing procedures for a display provided comprises: (A) production-lined parameters correspond to and base on respectively every process in manufacturing procedures of a display to establish a monitoring equation of estimating display attributes, wherein, calculating results of the monitoring equation is used to indicate display qualities; (B) when accomplishing a process of the display, the calculating results of the monitoring equation is updated based on an on-line feedback and the production-lined parameters corresponding to the process; (C) when the display qualities indicated from the updated calculating results in the step (B) are inappropriate for quality standards, production-lined parameters corresponding to a process after the previous process is performing an adjustment to make the display qualities appropriate for the quality standards. According to the aforementioned method, key attributes of displays can be kept within appropriate standards by production-lined parameters of post-adjusted process and then further increase display product productivity which is appropriate standards.

### FIELD OF THE INVENTION

The invention overall is related to a display manufacture. More specifically, it is related to an on-line actual-time monitoring method performed on manufacturing procedures for a display.

### BACKGROUND OF THE INVENTION

In display market of plenty brands, display qualities is one of key factors to determine market share; because several processes comprises in display productive procedures, if processes of procedures are considered too variable, thus display qualities are inappropriate to comply with the quality standards.

For example, Gamma, which is derived from an effective curve of a display, is one of key properties effecting liquid crystal display qualities and represents displaying brightness of the display and a non-linear relationship of inputting voltage, wherein, production-lined parameters corresponding to some processes of the liquid crystal display procedures are related to Gamma attribute, if larger drifts are occurred in production-lined parameters corresponding to a process to exceed Gamma attribute out of standards, thus display qualities of the liquid crystal display are inappropriate to quality standards.

In the present display procedure technologies, even inappropriate products occurred because of drifts of production-lined procedures are discovered in time, it is impossible to recover semi-productions which are on the way of productions.

### SUMMARY OF THE INVENTION

An exemplary embodiment of the present invention is provides a on-line actual-time monitoring method performed on manufacturing procedures for a display to overcome catastrophic failures of unqualified qualities of semi-manufactured goods in present technologies.

The present invention provide an on-line actual-time monitoring method performed on manufacturing procedures for a display, comprising: (A) production-lined parameters correspond to and base on respectively every process in manufacturing procedures of a display to establish a monitoring equation of estimating display attributes, wherein, calculating results of the monitoring equation is used to indicate display qualities; (B) when accomplishing a process of the display, the calculating results of the monitoring equation is updated based on an on-line feedback and the production-lined parameters corresponding to the process; (C) when the display qualities indicated from the updated calculating results in the step (B) are inappropriate for quality standards, production-lined parameters corresponding to a process after the previous process is performing an adjustment to make the display qualities appropriate for the quality standards.

Preferably, in step (A), the monitoring equation represents the linear-weighting of production-lined parameters, and, weighting of the production-lined parameters is confirmed by utilizing the least square method.

Preferably, the monitoring equation represents the equation as below:

$$S = {\sum }_{i = 1}^{n} {k}_{i} {X}_{i} ,$$

wherein, S is the display attribute, Xᵢ is all production-lined parameters corresponding to the ith process in the manufacturing procedures of the display, kᵢ is weighting of Xᵢ, and n is a process amount comprised in the manufacturing procedures of the display.

Preferably, the display is a liquid crystal display or an organic light-emitting display.

Preferably, the display attributes comprise at least one as below: Gamma attribute, a contrast attribute and a permeability attribute.

Preferably, the display is a liquid crystal display, and the display attribute is a Gamma attribute, wherein, every process in manufacturing procedures of the display comprises a PI process, an ITO process, a cell gap process, HVA process and LC process, wherein, production-lined parameters corresponding to the PI process comprise a thickness and a temperature; production-lined parameters corresponding to the ITO process comprise a fracture and the thickness; production-lined parameters corresponding to the cell gap process comprise a distance; production-lined parameters corresponding to the HVA process comprise a voltage, the temperature and an illumination; production-lined parameters corresponding to the LC process comprise an amount.

Preferably, in the step (B), applying respectively predetermined standard numeral numbers to update the calculating results from the monitoring equation for the production-lined parameters of a process located correspondingly after the previous process.

Preferably, in the step (C), an adjusting range of every production-lined parameters set in advance is preferably carried out to be adjusted to corresponding production-lined parameters of a process after previous the process by manual operations.

According to the on-line actual-time monitoring method performed on manufacturing procedures for a display in an exemplary embodiment of the present invention, catastrophic failure situations of unqualified qualities of semi-manufactured goods can be prevented by production-lined parameters of a post-adjusted process to keep key attributes within appropriate standards, and then further display product productivity can be increased within appropriate standards.

### BRIEF DESCRIPTION OF THE DRAWINGS

FIG. 1 is a flowchart of an on-line actual-time monitoring method performed on manufacturing procedures for a display according to an exemplary embodiment of the present invention.

### DETAILED DESCRIPTION OF THE INVENTION

Please refer to an exemplary embodiment of the present invention in detail, and the exemplary embodiment is shown in the accompanying drawing, wherein, like numerals refer to like elements throughout. The following will be described with reference to the accompanying drawing of the embodiment in order to explain the present invention.

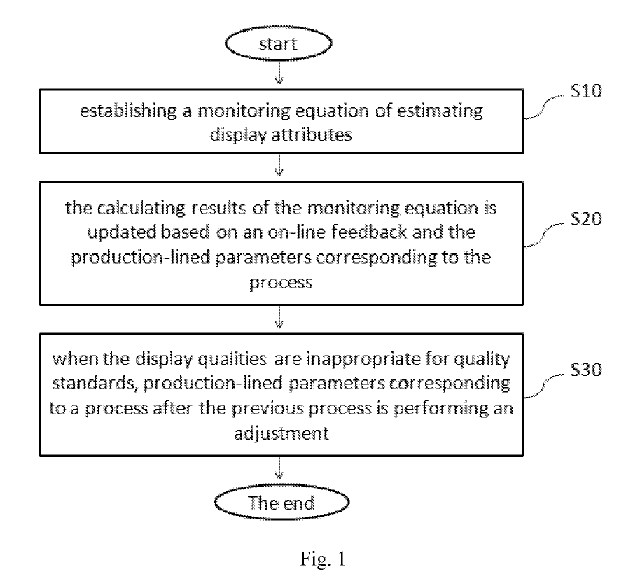

FIG. 1 is a flowchart of an on-line actual-time monitoring method performed on manufacturing procedures for a display according to an exemplary embodiment of the present invention. As an exemplary embodiment, the display is a liquid crystal display (LCD) or an organic light-emitting display (OLCD). It should be understandable the display is only limited to be the liquid crystal display or the organic light-emitting display, but also can be other display equipments.

As shown in FIG. 1, in step S10, production-lined parameters corresponding to and base on respectively every process in manufacturing procedures of a display to establish a monitoring equation of estimating display attributes, wherein, calculating results of the monitoring equation is used to indicate display qualities.

Here, in the actual production, display qualities are seriously affected by drifts of display attributes, and then production-lined parameters corresponding to every process in manufacturing procedures effect display attributes, therefore, production-lined parameters can correspond to and base on respectively every process in manufacturing procedures of a display to establish a monitoring equation of estimating display attributes. As the exemplary embodiment, the display attributes comprise at least one as below: Gamma attribute, a contrast attribute and a permeability attribute. The Gamma attribute can represent displaying brightness of a display and non-linear relationship of inputting voltage of the display; the contrast attribute represents a ratio of the displaying brightness; the permeability attribute represents efficiencies of a light permeability of the display. As an exemplary embodiment, the monitoring equation represents the linear-weighting of production-lined parameters, and, weighting of the production-lined parameters is confirmed by utilizing the least square method.

Specifically, the monitoring equation can be represented by equation 1 listed as below:

$$S = {\sum }_{i = 1}^{n} {k}_{i} {X}_{i} \qquad equation 1$$

wherein, S is the display attribute, Xᵢ is all production-lined parameters corresponding to the ith process in the manufacturing procedures of the display, kᵢ is weighting of Xᵢ, and n is a process amount comprised in the manufacturing procedures of the display. As exemplary embodiment in this case, Xᵢ is a vector combination of all production-lined parameters corresponding to the ith process in the manufacturing procedures of the display, kᵢ is a vector combination of weightings from every production-lined parameter corresponding respectively to the Ah process in the manufacturing procedures of the display.

For example, the display is a liquid crystal display, and the display attribute is a Gamma attribute, wherein, every process in manufacturing procedures of the display comprises a PI process, an ITO process, a cell gap process, HVA process and LC process, wherein, production-lined parameters corresponding to the PI process comprise a thickness and a temperature; production-lined parameters corresponding to the ITO process comprise a fracture and the thickness; production-lined parameters corresponding to the cell gap process comprise a distance; production-lined parameters corresponding to the HVA process comprise a voltage, the temperature and an illumination; production-lined parameters corresponding to the LC process comprise an amount.

Correspondingly, weighting of every production-lined parameter can be confirmed by the least square method based on the aforementioned production-lined parameters and Gamma standard values of on-lined monitoring to obtain a monitoring equation of estimating Gamma attribute.

A monitoring equation of Gamma attribute can be estimated by equation 2 listed as below:

$$S = [ \begin{matrix}{k}_{1} & {k}_{2}\end{matrix} ] [ \begin{matrix}{x}_{1} \\ {x}_{2}\end{matrix} ] + [ \begin{matrix}{k}_{3} & {k}_{4}\end{matrix} ] [ \begin{matrix}{x}_{3} \\ {x}_{4}\end{matrix} ] + {k}_{5} {x}_{5} + [ \begin{matrix}{k}_{6} & {k}_{7} & {k}_{8} & {k}_{9}\end{matrix} ] [ \begin{matrix}{x}_{6} \\ {x}_{7} \\ {x}_{8} \\ {x}_{9}\end{matrix} ] + {k}_{10} {x}_{10} \qquad equation 2$$

wherein, S represents Gamma attribute of the liquid crystal display, x₁ and x₂ in

$$[ \begin{matrix}{x}_{1} \\ {x}_{2}\end{matrix} ]$$

are respectively thickness production-lined parameters and temperature production-lined parameters corresponding to the PI process, and k₁ and k₂ in [k₁ k₂] are weighting of thickness production-lined parameters and weighting of temperature production-lined parameters; x₃ and x₄

$$[ \begin{matrix}{x}_{3} \\ {x}_{4}\end{matrix} ]$$

in are respectively fracture production-lined parameters and thickness production-lined parameters corresponding to the ITO process, and k₃ and k₄ in [k₃ k₄] are respectively weighting of fracture production-lined parameters and weightings of thickness production-lined parameters; x₅ is gap production-lined parameters corresponding to the cell gap process, k₅ is weighting of distance production-lined parameters, x₆ [symbol] x₇ [symbol] x₈ and x₉ in

$$[ \begin{matrix}{x}_{6} \\ {x}_{7} \\ {x}_{8} \\ {x}_{9}\end{matrix} ]$$

are voltage production-lined parameters, temperature production-lined parameters, time production-lined parameters and illumination production-lined parameters corresponding to the HVA process, and k₆ [symbol] k₇ [symbol] k₈ and k₉ are respectively weightings corresponding to voltage production-lined parameters, temperature production-lined parameters, time production-lined parameters and illumination production-lined parameters; x₁₀ is amount production-lined parameters corresponded to the LC process, and k₁₀ is weighting of amount production-lined parameters.

In step 20, when accomplishing a process of the display, the calculating results of the monitoring equation are updated based on an on-line feedback and the production-lined parameters corresponding to the process.

Specifically, production procedures of displays comprises several processes, and in predetermined orders existing in the process, when accomplishing a process of the display every time, the calculating results of the monitoring equation is updated based on an on-line feedback and the production-lined parameters corresponding to the process; thus, applying values of on-lined feedback and production-lined parameters corresponded to the process into the monitoring equation to obtain further updated calculating results. It should be noted here that predetermined standard values can be applied into the monitoring equation for unperformed process. In other words, for production-lined parameters of a process located after the previous process, the calculating results of the monitoring equation can be updated by applying respectively predetermined standard values.

In step 30, when the display qualities indicated from the updated calculating results in the step S20 are inappropriate for quality standards, production-lined parameters corresponding to a process after the previous process is performing an adjustment to make the display qualities appropriate for the quality standards.

Specifically, when updated calculating results in the step S20 indicates inappropriate quality standards of display qualities, the accomplished process can be confirmed in inappropriate quality standards from the displays qualities. For example: when Gamma calculating results of updated display attributes at the time that the gap cell process completes is out of standards (ex: Gamma=2.3), production-lined parameters corresponding to the following process (which is a process located after the cell gap process) can be performing adjustment to have the display qualities complied with quality standards. Here, as an exemplary embodiment, an adjusting range of every production-lined parameter set in advance is preferably carried out to be adjusted to correspond to production-lined parameters of a process after the previous process by manual operations. According to the aforementioned method, key attributes of the display can be kept within appropriate standards by adjusting production-lined parameters of the following-processes to recover semi-manufactured goods.

It can be seen that key attributes of the display can be kept within appropriate standards by adjusting production-lined parameters of the following processes in the on-line actual-time monitoring method performed on manufacturing procedures for the display to further prevent catastrophic failure situations of unqualified qualities happened to semi-manufactured products and then increase display product productivity which is appropriate standards.

Although the invention has been shown and described with reference to certain exemplary embodiments thereof, it will be understood by those skilled in the art that various changes in form and details may be made therein without departing from the spirit and scope of the invention as defined by the appended claims and their equivalents.

1, An on-line actual-time monitoring method performed on manufacturing procedures for a display comprises:
(A) production-lined parameters correspond to and base on respectively every process in manufacturing procedures of a display to establish a monitoring equation of estimating display attributes, wherein, calculating results of the monitoring equation is used to indicate display qualities;
(B) when accomplishing a process of the display, the calculating results of the monitoring equation is updated based on an on-line feedback and the production-lined parameters corresponding to the process;
(C) when the display qualities indicated from the updated calculating results in the step (B) are inappropriate for quality standards, production-lined parameters corresponding to a process after the previous process is performing an adjustment to make the display qualities appropriate for the quality standards.

2, The method according to claim 1, wherein, in step (A), the monitoring equation represents the linear-weighting of production-lined parameters, and, weighting of the production-lined parameters is confirmed by utilizing the least square method.

3, The method according to claim 2, wherein, the monitoring equation represents the equation as below:
$$S = {\sum }_{i = 1}^{n} {k}_{i} {X}_{i} ,$$
wherein, S is the display attribute, Xᵢ is all production-lined parameters corresponding to the ith process in the manufacturing processes of the display, kᵢ is weighting of Xᵢ, and n is a process amount comprised in the manufacturing procedures of the display.

4, The method according to claim 1, wherein, the display is a liquid crystal display or an organic light-emitting display.

5, The method according to claim 4, wherein, the display attributes comprise at least one as below: Gamma attribute, a contrast attribute and a permeability attribute.

6, The method according to claim 1, wherein, the display is a liquid crystal display, and the display attribute is a Gamma attribute,
wherein, every process in manufacturing procedures of the display comprises a PI process, an ITO process, a cell gap process, HVA process and LC process, wherein, production-lined parameters corresponding to the PI process comprise a thickness and a temperature; production-lined parameters corresponding to the ITO process comprise a fracture and the thickness; production-lined parameters corresponding to the cell gap process comprise a distance; production-lined parameters corresponding to the HVA process comprise a voltage, the temperature and an illumination; production-lined parameters corresponding to the LC process comprise an amount.

7, The method according to claim 2, wherein, in the step (B), applying respectively predetermined standard numeral numbers to update the calculating results from the monitoring equation for the production-lined parameters of a process located correspondingly after the previous process.

8, The method according to claim 1, wherein, in the step (C), an adjusting range of every production-lined parameters set in advance is preferably carried out to be adjusted to corresponding production-lined parameters of a process after previous the process by manual operations.
